(19) United States
(12) Patent Application Publication
(10) Pub. No.: US 2022/0126716 A1
(43) Pub. Date: Apr. 28, 2022

(54) Range Extending Platform

(71) Applicant: William J. Neff, Sandy, UT (US)

(72) Inventor: William J. Neff, Sandy, UT (US)

(21) Appl. No.: 17/083,166

(22) Filed: Oct. 28, 2020

(51) Int. Cl. B60L 53/36; B60L 53/12; B60L 53/38; B60L 53/51; B60L 53/52

(52) U.S. Cl. CPC B60L 53/36; B60L 53/12; B60L 53/38; B60L 2200/32; B60L 53/52; B60L 2200/10; B60L 53/51

(57) ABSTRACT

A Range Extending Platform system that generates energy independent of the electrical grid through an energy generating device and transmits it wirelessly to a vehicle or device to recharge a battery is disclosed. The system comprising a device that generates energy from the physical environment (e.g., wave energy converter, wind turbine, photovoltaic cell, nuclear fission, etc.) and provides that power to a wireless power transfer platform. The wireless power transfer platform having the ability to wirelessly transfer power from its transmitter device to a receiver device (e.g., attached to a battery electric vertical take-off and landing (VTOL) drone, battery electric car, battery electric portable device, etc.) to recharge a battery thereby extending the range or use of the item containing the receiver device without having to be manually plugged in to be recharged or swapping out the battery. This is particularly useful in remote locations off the electrical grid.

### FIELD OF THE INVENTION

This disclosure relates to a platform that is connected to an in situ energy generation device, which produces energy and stores the energy that is used to provide electrical power to a wireless power transfer (WPT) structure, which is used to recharge electric batteries wirelessly without a physical link, together the “Range Extending Platform”. This technology may be used to generate energy in remote locations and enable recharging platforms for electric powered vehicles and devices, which then in turn extends the range of use of these vehicles or devices, whether airborne, seaborne, or land-based.

### BACKGROUND OF THE INVENTION

Currently, the principal approaches for recharging electric batteries to extend the time of operation for electric powered vehicles, including unmanned aerial vehicles (UAVs), drones or other robotic self-propelled or portable devices, whether airborne, seaborne, or land-based, is to return the vehicle to its point of origin to plug in the device to recharge it or to manually swap out the battery(ies) so it can continue on with its objective.

In many designs, the vehicle itself is streamlined to more efficiently use the battery power onboard before the battery is depleted and more efficient and longer lasting batteries continue to be developed, yet the problem of limited battery power and hence limited range of operations persists and limits the effective use of many electric-powered vehicles in numerous missions and applications.

One specific need for extended range is that of battery electric powered aircraft for conducting military intelligence, surveillance, and reconnaissance (ISR) missions, to be able to continue to conduct operations without continuously returning to base to recharge the battery thereby limiting the radius of the surveyed area. Another is for battery electric submarines or battery electric land vehicles.

It is therefore desirable to have a battery electric vehicle recharging station at intervals in the ocean, air, or land which allows for continuous active operations while en route to a destination or patrolling a region from which to conduct activities. For airborne operations, the wireless power transfer platform may be configured to serve as a deck for vertical take-off and landing (VTOL) aircraft or as a runway from which non-VTOL aircraft may take-off or land. This present invention provides for a flat structure to be affixed to the rigid frame of an in situ energy generator or to be connected to the energy generator device through electrical wires or such so as to transmit the electricity being generated from the energy generator to the wireless power transfer platform. This WPT platform is equipped with sensors so that when a vehicle or device is in contact with the WPT platform's surface, or nearby above the surface, then the WPT turns on and begins to transmit power to the receiving body. Therefore, the wireless power transfer platform is the transmitter device, driven by electric power from the energy generator and generates a time-varying electromagnetic field, which transmits power across space to the receiver device (on the aircraft, ship, vehicle, etc.), which extracts power from the electromagnetic field and supplies it to the onboard battery pack of the receiving vehicle. This technology eliminates the use of the wires and swapping out batteries, thus increasing the mobility, convenience, and safety of an electronic vehicle or device. This in situ energy generator and WPT platform is useful to power electrical vehicles and devices remotely where access to electricity is not available and interconnecting wires are inconvenient, hazardous, or are not possible.

### SUMMARY

The following implementations and aspects thereof are described and illustrated in conjunction with systems, machines, and methods that are meant to be exemplary and illustrative, not necessarily limiting in scope. In various implementations one or more of the above-described problems have been addressed, while other implementations are directed to other improvements.

Beneficially, the Range Extending Platform according to the invention disclosed herein allows for recharging of vehicles and devices off the electrical grid for continued use.

The invention advantageously uses a system for providing energy production in a remote area from the energy generator and has the ability to transmit the electric current through space via magnetic fields or electric fields using inductive coupling, capacitive coupling, magnetodynamic coupling, or through waves (i.e., microwaves, light waves, etc.) to a receiving device to supply an electric load.

Firstly, in various embodiments, the invention is implemented as a sea-based platform in the which a wave energy converter (WEC) device harnesses marine hydrokinetic energy, the kinetic energy associated with moving water such as from ocean waves. The wave energy converter device can convert wave motion into energy in various ways, typically using devices that ride up and down on wave crests and troughs and, in the process, driving a mechanical linkage that turns a generator, There are five primary types of WEC systems, all of which capture the kinetic energy between two bodies relative to one another: oscillating water column (or “terminator”) devices, point absorbers, attenuators, and overtopping devices, as well as traditional water wheel devices, Oscillating water column devices look like inverted cones that are partially submerged and are open in the bottom. As the water level rises and falls from passing waves, the air trapped beneath the “cone” operates like a piston, powering an internal turbine generator. Point absorbers use a floating device, to ride the vertical motions of waves, pressurizing a fluid (e.g., seawater) and driving a turbine. Attenuators are long, jointed structures that are positioned parallel to waves with anchors at either end; they generate energy from the segments' opposing rotational motion as waves move along the converter. Overtopping devices operate like small floating reservoirs that capture seawater from breaking waves, creating pressure that turns a rotor as the water falls from the reservoir, Water wheels consist of a wheel, with a number of blades or buckets arranged on the outside rim forming the driving car which flowing or falling water push against to rotate the wheel.

The WEC then stores the generated energy inside of battery storage area, which may be below the water surface, for instance incorporated into the heave plate, or above the waterline, or in a separate location connected by an electrical cable.

The WEC may be either moored to the ocean floor or if sufficient energy is generated a propulsion system may be incorporated into the WEC so as to keep the WEC in position in the ocean without moving out of the area with the ocean current.

The WEC is either attached directly to the wireless power transfer (WPT) platform with the WPB′ platform on top in a horizontal position or on the side in a vertical position from which an aircraft or submarine can land on or move in an adjacent position with, respectively, to recharge; or the WPT may not be physically attached to the WEC other than through a cable that provides electric energy to the WPT.

The WPT is kept afloat through air in the spars or other supporting structure giving the system buoyancy in the water so that the WPT landing pad may remain above the surface of the water.

Depending on the particular WEC device used to generate energy, some may have a mooring line attached to an anchor on the ocean floor or something to keep the system in a general location if desired. As wave energy decreases deeper in the water, below a depth of half the wavelength (D L), water is unaffected by the wave energy at the surface. Therefore, some WEC devices have a heave plate that is located at a depth of over half of the wavelength that acts as ballast to the system and the column of water above the heave plate keeps the system from moving up and down with the waves.

Secondly, in various embodiments the invention is implemented as an airborne platform in which the wave energy converter, in this case air waves (i.e, wind) or solar waves (i.e., photons) are harvested, through a wind turbine or photovoltaic cell for instance. Wind turbines harness energy from wind through the aerodynamic lift generated across rotor blades from passing air. The lifting force over the blades causes the rotor to turn, which in turn spins the generator, which converts harvested energy into electricity. The wind turbine consisting of any of the numerous designs for harvesting wind. For the solar panel energy generator, the photovoltaic cell, an electrical device that converts the energy of light directly into electricity by the photovoltaic effect, which is a physical and chemical phenomenon. It is a form of photoelectric cell, a device whose electrical characteristics, such as current, voltage, or resistance, vary when exposed to light. The airborne platform may also encompass a lifting gas cell which provides buoyancy to keep the Range Extending Platform aloft, comprising the connected WEC, energy storage, and WPT platforms.

As with the sea-based platform, the airborne platform may be tethered to the ground or if sufficient energy is generated a propulsion system may be incorporated into the platforms so as to keep it in position in the sky without the platform moving out of the area with the wind.

Additionally; in various embodiments, the energy storage area or battery pack may be connected directly to the airborne-WEC WPT platform or may be connected by electrical cables. The battery pack may also take the form of an anchor base of the tether with electrical wires or cables connecting it to the WEC and WPT platform.

As with the sea-based platform, the WPT platform portion of the airborne Range Extending Platform is configured so as to turn on when a vehicle or device is located on its surface or near it and will start sending out power to the receiver device to recharge a battery.

Thirdly, in various embodiments the invention is implemented as a land-based platform in which the WTP is connected to the electrical grid or operates off the grid through a energy generator such as a wave energy converter as previously discussed in the sea-based or airborne WECs by harvesting energy from water, wind, or solar from the land-based platform.

For the land-based Range Extending Platform the WPT may be on a raised platform such as a tower to aid in aircraft landing on the WPT platform. The Range Extending Platform may also be directly on the surface of the ground so that a vehicle may drive on or over the WPT platform and recharge its batteries or other electrical devices can be placed on the WPT platform for recharging.

Additionally, in various embodiments, the WPT platform is built of a strong lightweight composite that is sufficiently strong to support the impact and weight of various operations conducted on its surface, including, but not limited to the landing and taking-off of aircraft, drones, and other vehicles and devices.

These and other advantages will become apparent to those skilled in the relevant art upon a reading of the following descriptions and a study of the several examples of the drawings.

### BRIEF DESCRIPTION OF THE DRAWINGS

The present invention can be put into practice in various ways, but embodiments will now be described by way of example only with reference to the accompanying drawings in which:

FIG. 1 shows an illustrative embodiment of a sea-based Range Extending Platform with the Wave Energy Converter (WEC) device generating electricity, which may be stored in a battery pack, to power the Wireless Power Transfer (WPT) platform shown here as a landing pad accessible to vertical take-off and landing (VTOL) aircraft.

FIG. 2 shows an illustrative embodiment of a sea-based Range Extending Platform in which numerous WECs provide power, which may be stored in a battery pack, to the WPT platform shown here as a landing pad for VTOL aircraft to land on.

FIG. 3 shows an illustrative embodiment of an airborne Range Extending Platform with the energy generator consisting of a lifting gas cell for increased buoyancy and wind turbines depicting the energy generator system that provides power, which may be stored in a battery pack, the WPT platform shown here as a landing pad for VTOL aircraft to land on.

FIG. 4 shows an illustrative embodiment of a land-based Range Extending Platform with the energy generator providing power, which may be stored in a battery pack, to a raised WPT platform shown here as a landing pad for VTOL aircraft to land on. The type of energy generator here is not specifically described, but could take the form of a device to harvest wind or sunlight, or other device used to generate electricity off the electrical grid.

FIG. 5 shows an illustrative embodiment of a land-based Range Extending Platform with the energy generator providing power, which may be stored in a battery pack, to a WPT platform at ground level shown here as a recharging pad for vehicles, robotic or otherwise, to drive and park over to recharge. The type of energy generator here is not specifically described, but could take the form of a device to harvest wind or sunlight, or other device used to generate electricity off the electrical grid.

### DETAILED DESCRIPTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, any claims herein are not to be limited to that embodiment. Moreover, any such claims are not to be read restrictively unless there is clear and convincing evidence manifesting a certain exclusion, restriction, or disclaimer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art.

One or more embodiments of a platform capable of staying afloat for long periods of time at sea or in the air or situated on the ground all of which are capable of generating electricity independently from the electrical grid and providing this electrical power wirelessly to a receiving device to provide power to a vehicle or device,

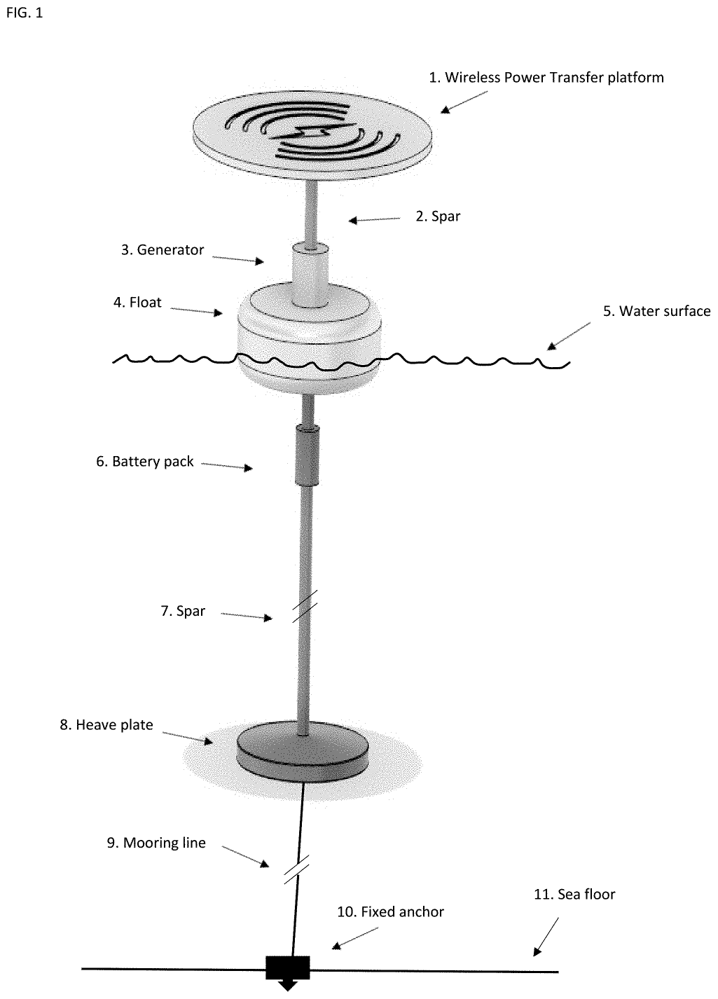

FIG. 1 is depicting one possible configuration of an illustrative embodiment of Range Extending Platform system comprising 1, a Wireless Power Transfer (WPT) platform that has the appearance of a landing pad accessible to vertical take-off and landing (VTOL) aircraft with the platform affixed to 2. a spar or supporting structure that also supports an energy generating device consisting of 3. a generator capable of turning physical movement into electricity and 4. a float providing the movement from the 5. up and down motion of the waves on the surface of the water. This depiction shows a 6. battery pack to store the generated energy attached to 7. a spar extending down into the water and buoyant to keep the system afloat while attached to 8, a heave plate below a depth that is affected by waves at the surface to keep the system from moving up and down with the waves. This depiction shows the 8. Heave plate attached to a 9. mooring line affixed to 10. an anchor on 11. the seafloor.

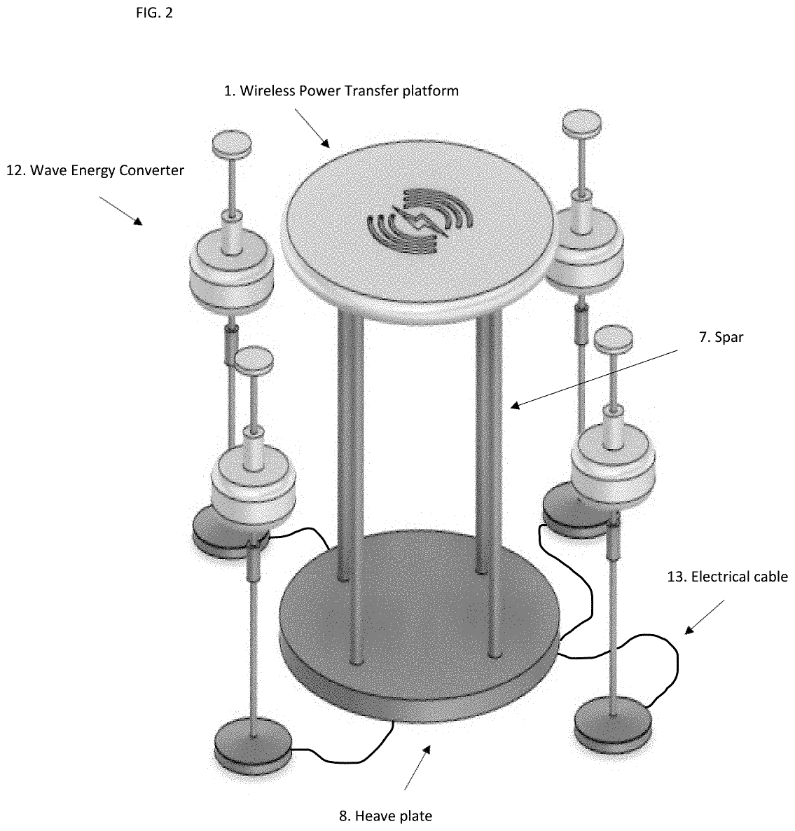

FIG. 2 is depicting one possible configuration of an illustrative embodiment of a sea-based Range Extending Platform system comprising 1. a WPT platform that has the appearance of a landing pad accessible to VTOL aircraft with the platform affixed to 7. spars or supporting structure extending down into the water and sufficiently buoyant to keep the system afloat while attached to 8. a heave plate below a depth that is affected by waves at the surface to keep the system from moving up and down with the waves. This depiction shows a “WEC farm” or multiple 12. Wave Energy Converters providing power to the 1. WPT vis 13. Electrical cables.

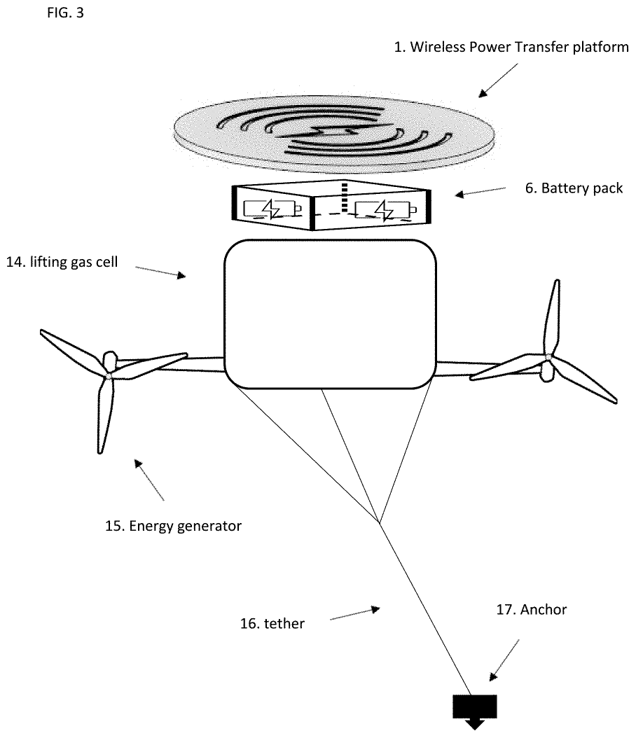

FIG. 3 is depicting one possible configuration of an illustrative embodiment of an airborne Range Extending Platform system comprising 14. a lifting gas cell to keep the system aloft. The system generates power through 15. an energy generator, here depicted as a wind turbine device, that provides power to 6. a battery pack, which in turn powers 1. a WPT platform that has the appearance of a landing pad accessible to VTOL aircraft. This depiction shows Range Extending Platform being 16. tethered to 17, an anchor on the ground keeping the system in the general vicinity.

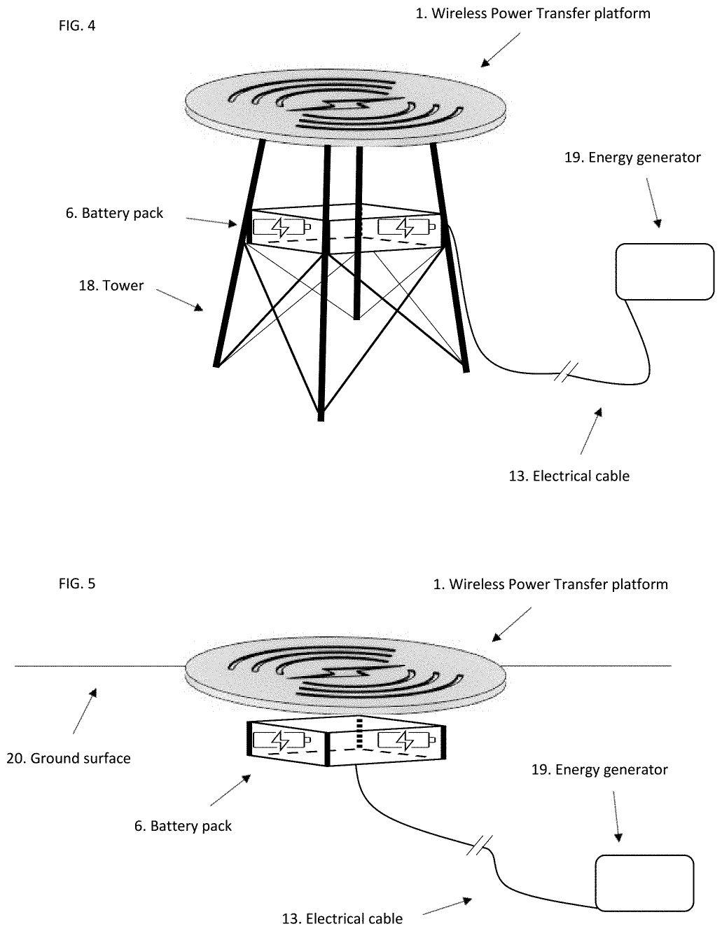

FIG. 4 is depicting one possible configuration of an illustrative embodiment of a land-based Range Extending Platform system comprising 18. a tower or structure to support the WPT platform. This depiction shows 19. an energy generator providing power via 13, an electrical cable to 6. a battery pack, which stores the power to be used in 1. the WPT platform shown here as a landing pad for VTOL aircraft to land on.

FIG. 5 is depicting one possible configuration of an illustrative embodiment of a land-based Range Extending Platform system comprising 1. a WPT platform at 20, ground level. This depiction shows 19. an energy generator providing power via 13, an electrical cable to 6. a battery pack, which stores the power to be used in 1. the WPT platform shown here as a recharging pad for vehicles, robotic or otherwise, to drive and park over to recharge.

1. A Range Extending Platform system that generates energy independent of the electrical grid through an energy generating device and transmits it wirelessly to a vehicle or device to recharge a battery. The system comprising a device that generates energy from the physical environment (e.g., wave energy converter, wind turbine, photovoltaic cell, nuclear, etc.) and provides that power to a wireless power transfer platform. The wireless power transfer platform having the ability to wirelessly transfer power from its transmitting device to a receiver device (e.g., attached to a battery electric vertical take-off and landing (VTOL) drone, battery electric car, battery electric portable device, etc.) to recharge a battery thereby extending the range or use of the item containing the receiver device.

2. The Range Extending Platform system according to claim 1, wherein the energy generator is connected to a power storage device (e.g., a battery pack) which stores the generated power and is connected to the wireless power transfer platform in a manner that enables it to provide power on demand to the wireless power transfer platform.

3. The Range Extending Platform system according to claim 1, wherein the wireless power transfer platform is physically attached to the structure of the energy generator.

4. The Range Extending Platform system according to claim 1, wherein the wireless power transfer platform is connected to the energy generator with an electrical wire from which it receives power generated by the energy generator.

5. The Range Extending Platform system according to claim 1, wherein the wireless power transfer platform is flat and performs the function of a landing pad or runway upon which electric VTOL aircraft may take-off, land, or perform other activities while on the platform.

6. The Range Extending Platform system according to claim 1, wherein the wireless power transfer platform is affixed to a raised structure above the surface of the water.

7. The Range Extending Platform system according to claim 1, wherein the wireless power transfer platform is affixed to the side of a structure below the surface of the water so as to recharge marine vessels.

8. The Range Extending Platform system according to claim 1, wherein the wireless power transfer platform is affixed to an airborne structure that stays afloat in the sky (e.g., a lifting gas cell, airship, aircraft, etc.).

9. The Range Extending Platform system according to claim 1, wherein the wireless power transfer platform is affixed to an airborne structure that is tethered to the ground.

10. The Range Extending Platform system according to claim 1, wherein the wireless power transfer platform is near level with the ground so as to allow vehicles to drive and park over it to recharge.

11. The Range Extending Platform system according to claim 1, wherein the wireless power transfer platform is able to secure aircraft, vehicles, or devices while recharging or while other activities are being conducted.

12. The Range Extending Platform system according to claim 1, wherein the wireless power transfer platform has sensors to turn on the flow of power from the transmitting device to a receiving device by sensing that the receiving device is near the platform.

13. The Range Extending Platform system according to claim 1, wherein the wireless power transfer platform uses global position satellite coordinates to relay to the receiving device the exact location to help the receiver device stop above the wireless power transfer platform in order to effectively recharge.

14. The Range Extending Platform system according to claim 1, wherein the wireless power transfer platform uses a homing beacon with the receiver device to be in the correct position to recharge.

15. The Range Extending Platform system according to claim 1, wherein the energy generator device is comprising mechanisms to harvest hydrokinetic power from water to generate electricity.

16. The Range Extending Platform system according to claim 1, wherein the energy generator device is comprising mechanisms to harvest wind power to generate electricity.

17. The Range Extending Platform system according to claim 1, wherein the energy generator device is comprising mechanisms to harvest solar power to generate electricity.

18. The Range Extending Platform system according to claim 1, wherein the system is moored to the ocean floor or tether to the ground or has an onboard propulsion system to maintain the general vicinity.

19. The Range Extending Platform system according to claim 1, wherein the system has the ability to be attached to the electrical grid to provide power to the wireless power transfer platform or physically plug into the receiver device to recharge the battery.

20. The Range Extending Platform system according to claim 1, wherein the system is connected to more than one energy generator or energy storage device or as part of a larger system comprising numerous Range Extending Platforms so as to allow a vehicle go from one platform to another to cross great distances.
